(19) United States
(12) Patent Application Publication
(10) Pub. No.: US 2026/0200227 A1
(43) Pub. Date: Jul. 16, 2026

(54) LIQUID EJECTION HEAD

(71) Applicant: CANON KABUSHIKI KAISHA, Tokyo (JP)

(72) Inventors: YASUNORI TAKEI, Tokyo (JP); TAKATSUGU MORIYA, Tokyo (JP); KOICHI ISHIDA, Tokyo (JP); YOSHIHIRO HAMADA, Kanagawa (JP); SAORI NARUKAWA, Kanagawa (JP); TAKUMA KODOI, Kanagawa (JP)

(21) Appl. No.: 19/449,744

(22) Filed: Jan. 15, 2026

(30) Foreign Application Priority Data
Jan. 16, 2025 (JP) 2025-006113

(51) Int. Cl. B41J 2/14

(52) U.S. Cl. CPC B41J 2/1433; B41J 2/1404; B41J 2002/14475

(57) ABSTRACT

Providing a liquid ejection head ejecting a liquid from an ejection port by applying energy to the liquid, in which the ejection port includes an opening portion having a longitudinal direction and a transverse direction, the opening portion includes a protrusion, first regions, and a second region, the protrusion is arranged in each of facing positions of the ejection port in the longitudinal direction, the first regions are regions excluding the protrusions of the ejection port that are along the longitudinal direction and partitioned by the protrusions, the second region is a region excluding the protrusions of the ejection port that bridges the first regions between the facing protrusions, and M/L>1.0 and (L−a)/2L<0.4 are satisfied where the maximum length in the longitudinal direction is M, the maximum length in the transverse direction is L, and a half width of the protrusion is a.

### BACKGROUND

### Field of the Technology

The present disclosure relates to a liquid ejection head that performs printing by ejecting a liquid such as an ink to various media.

### Description of the Related Art

An ink jet printing method has been known as a method of ejecting a liquid such as an ink that is recently used widely and generally. The ink jet printing method includes a method of using an electrothermal conversion element (a heater) and a method of using a piezoelectric element (piezo) as an ejection energy generation element to eject a liquid droplet. Both the elements are capable of controlling ejection of the liquid droplet by an electric signal.

Along with an increase in the density of ejection ports in the liquid ejection head and the downsizing of the ejected liquid droplet in recent years, it has been difficult to ignore an effect of the liquid droplet that does not contribute to the proper print. As a specific example of the effect of the liquid droplet as described above, there is a deterioration of an image due to splitting of the liquid droplet of the ink and the like landing on the printing medium into multiple droplets (a main droplet and satellites). In addition to this, in some cases, the liquid droplet loses the speed before reaching the printing medium and becomes a floating liquid droplet (in the present specification, also referred to as mist), which becomes contamination on a printing apparatus, and the contamination is transferred to the printing medium.

To deal with generation of the satellites and the mist as described above, for example, there is a method of providing an opening portion having a specific shape to the ejection port as described in International Publication No. WO2007/064021 (PTL 1). The method described in PTL 1 suppresses generation of the satellites and the mist by providing multiple protrusions to the opening portion ejecting the liquid, in which the protrusions hasten the timing of separation of an ejected liquid column from the opening portion and shorten the length of the liquid column.

In order to suppress the satellites by the method in PTL 1, a region between the protrusions to hold a liquid surface connecting to the liquid and a region formed on two sides of the other protrusions are required. In order to provide the above-described opening portion, a certain space is required in the opening portion depending on an amount of the ejected liquid. However, because of the high density of the ejection ports in recent years, a sufficient space to provide the above-described opening portion cannot be secured in some cases.

In a case of providing the ejection port of PTL 1 to a limited space, adopting of a shape deformed to fit the space is considered. However, in a case of the ejection port having the above-described deformed shape, an originally expected ejection state of the liquid is not obtained, and the suppression of the satellites and the mist is not sufficiently achieved in some cases.

### SUMMARY

The present disclosure is directed to a liquid ejection head that can improve suppression of satellites and mist. The liquid ejection head of the present disclosure is configured to eject a liquid from an ejection port by applying energy to the liquid from an energy generation element, in which the ejection port includes an opening portion having a longitudinal direction and a transverse direction, the opening portion includes a protrusion, first regions, and a second region, the protrusion is arranged in each of facing positions of the ejection port in the longitudinal direction, the first regions are regions excluding the protrusions of the ejection port and are regions of the opening portion that are along the longitudinal direction and partitioned by the protrusions, the second region is a region excluding the protrusions of the ejection port and is a region of the opening portion that bridges the first regions between the facing protrusions, and the following formulae (A) and (B) are satisfied:

$$M / L > 1. ; \qquad ( A )$$

$$( L - a ) / 2 L < 0.4 , \qquad ( B )$$

where
the maximum length in the longitudinal direction is M, the maximum length in the transverse direction is L, and a half width of the protrusion is a.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are perspective views of a liquid ejection head of the present disclosure;

FIG. 2 is a perspective view illustrating a printing element substrate of the liquid ejection head of the present disclosure;

FIG. 3 is a cross-sectional view of the liquid ejection head illustrated in FIG. 2 taken along a line III-III;

FIGS. 4A to 4C are diagrams illustrating an ejection port, a bubble generation chamber, and a liquid channel of a liquid ejection unit according to a comparative example, FIG. 4A is a front view, FIG. 4B is a cross-sectional view taken along IVb-IVb in FIG. 4A, and FIG. 4C is an enlarged view of the ejection port in FIG. 4A;

FIGS. 5A to 5C are diagrams illustrating the ejection port, the bubble generation chamber, and the liquid channel of the liquid ejection unit of a first embodiment, FIG. 5A is a front view, FIG. 5B is a cross-sectional view taken along Vb-Vb in FIG. 5A, and FIG. 5C is an enlarged view of the ejection port in FIG. 5A;

FIG. 6 is a diagram illustrating an ejection step of a liquid in the ejection port provided with a protrusion;

FIG. 7 is a diagram illustrating a result of simulating a behavior of the liquid in the ejection port of the comparative example;

FIG. 8 is a diagram illustrating a result of simulating a behavior of the liquid in the ejection port of the first embodiment;

FIGS. 9A and 9B are diagrams illustrating results of simulating a flying state of the liquid in the comparative example and the first embodiment, respectively;

FIG. 10 is a diagram illustrating a shape of the ejection port applicable to the present disclosure; and

FIGS. 11A and 11B are diagrams exemplifying a mode of the liquid channel applicable to the present disclosure, FIG. 11A is a front view, and FIG. 11B is a cross-sectional view taken along XIb-XIb in FIG. 11A.

### DESCRIPTION OF THE EMBODIMENTS

A liquid ejection head of the present disclosure is described below with reference to the drawings. In the descriptions of the present specification, directions may be defined by an X axis, a Y axis, and a Z axis. The axes are indicated by directional axes that are provided with arrows and illustrated in each drawing. As for the axes of the corresponding directions, a direction to which the arrow is pointing is defined as a “+” direction of each axis. Additionally, as for each axis, in a case of mentioning the direction of the axis without specifying the direction “+” or “−,” it is referred to simply as an “X axis direction,” a “Y axis direction,” or a “Z axis direction.” In a comparative example and each embodiment of an ejection port described in the present specification, a long axis direction of a shape of the ejection port is referred to as a “longitudinal direction.” In the comparative example and each embodiment of the ejection port described in the present specification, a direction perpendicular (orthogonal) to the “longitudinal direction” or, in other words, a short axis direction of the ejection port is referred to as a “transverse direction.” In the comparative example and each embodiment described in the present specification, the longitudinal direction is a direction along a liquid channel in which the ejection port is formed, and the transverse direction is a direction orthogonal to the longitudinal direction.

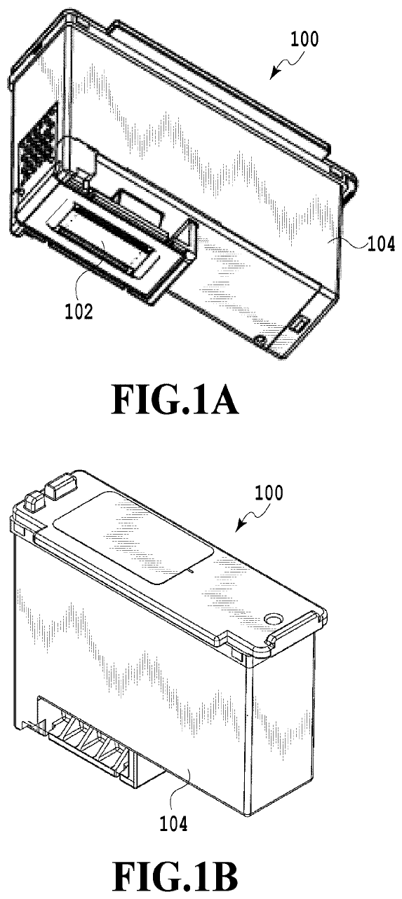

Hereinafter, each embodiment of the liquid ejection head of the present disclosure is described with reference to the drawings. In the following description, first, the liquid ejection head of the present disclosure is described with reference to FIGS. 1 to 3. Subsequently, (1) the comparative example (a comparable) and (2) each embodiment of the present disclosure are described regarding a liquid ejection unit of the liquid ejection head. The liquid ejection head of the present disclosure is configured to eject a liquid from the ejection port by applying energy from an energy generation element to the liquid.

### (Liquid Ejection Head)

FIGS. 1A and 1B are perspective views illustrating the liquid ejection head of the present disclosure. FIG. 1A is an appearance perspective view of a liquid ejection head 100 viewed from a side of a printing element substrate 102. FIG. 1B is an appearance perspective view of the liquid ejection head 100 viewed from an upper surface side (the opposite side of the printing element substrate). As illustrated in FIGS. 1A and 1B, the liquid ejection head 100 includes a housing 104. The liquid is retained inside the housing 104. The liquid is supplied to the printing element substrate 102 and ejected from the ejection port provided in the printing element substrate 102.

### (Printing Element Substrate)

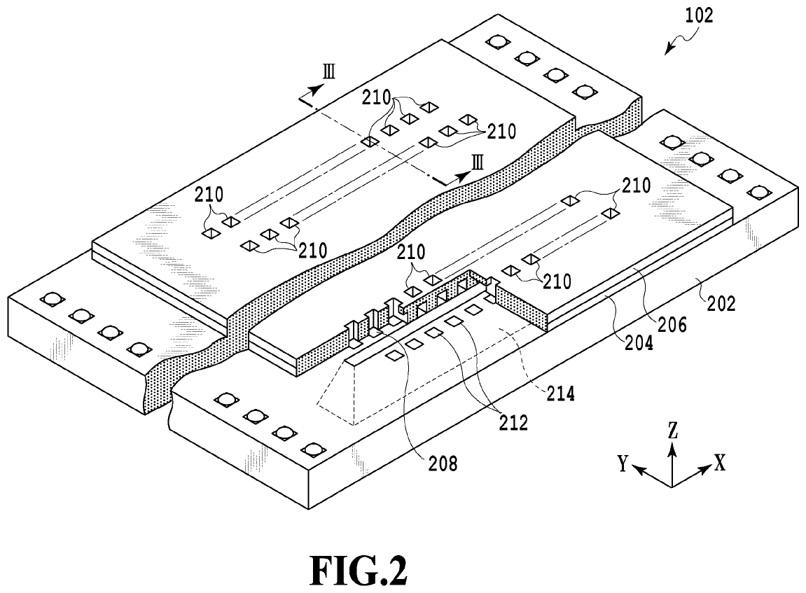

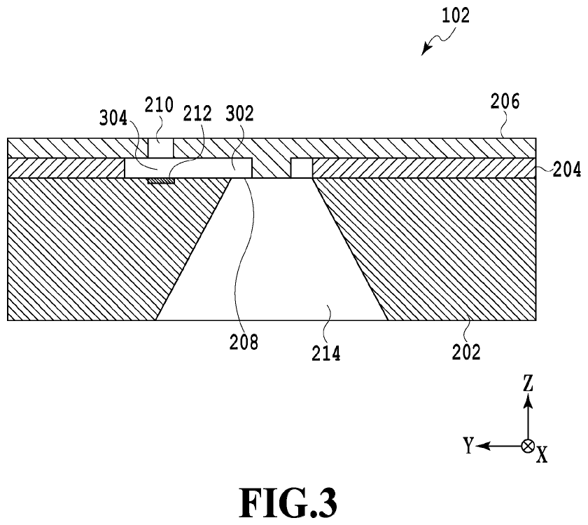

The printing element substrate 102 of the present disclosure is described with reference to FIGS. 2 and 3.

FIG. 2 is a perspective view illustrating the printing element substrate 102 of the present disclosure. FIG. 3 is a cross-sectional view of the printing element substrate 102 in a cross section taken along III-III illustrated in FIG. 2. The printing element substrate 102 of the present disclosure includes a substrate main body 202, a channel configuration unit 204, and an ejection port plate 206. The substrate main body 202 includes a liquid supply port 208, an electrothermal conversion element 212, and a common liquid chamber 214. As illustrated in FIG. 3, the channel configuration unit 204 includes a liquid channel 302 and a bubble generation chamber 304. The ejection port plate 206 includes an ejection port 210. The liquid is supplied from the liquid supply port 208 formed in the substrate main body 202 to the liquid channel 302 in the channel configuration unit 204 and then supplied to the ejection port 210 by way of the bubble generation chamber 304. The liquid supplied to the ejection port 210 is provided with energy from the electrothermal conversion element 212 that is formed on a substrate main body and arranged to form an array to be ejected from the ejection port 210.

### (Liquid Ejection Unit)

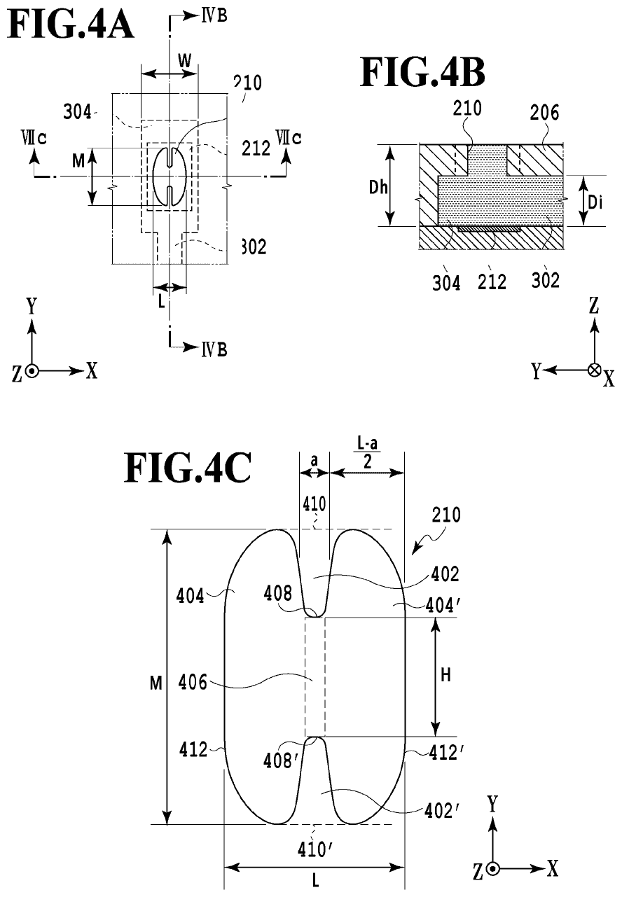

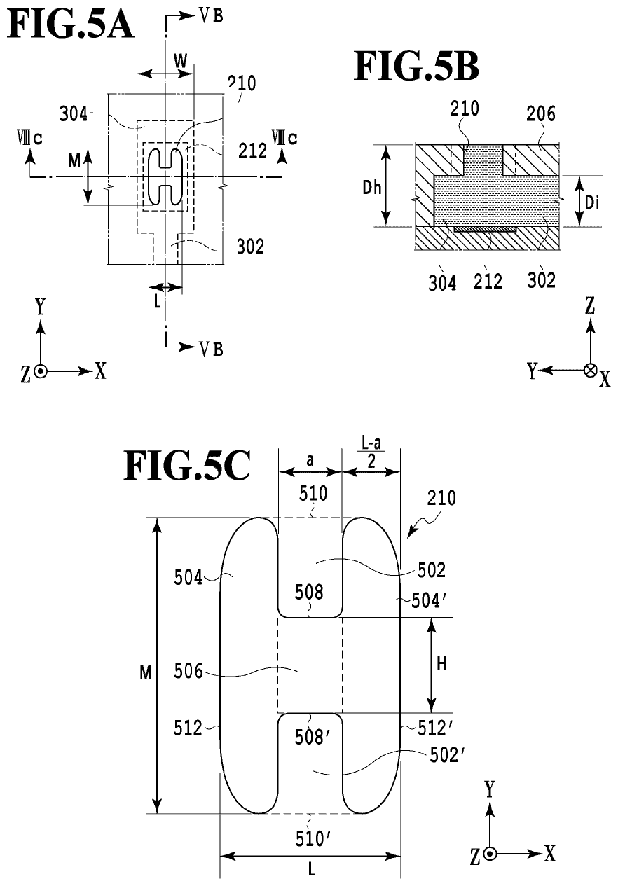

The liquid ejection head of the present disclosure includes the printing element substrate 102 including the above-described substrate main body 202, channel configuration unit 204, and ejection port plate 206 as illustrated in FIGS. 2 and 3. The printing element substrate 102 includes the liquid ejection unit formed of the liquid channel 302, the ejection port 210, the electrothermal conversion element 212, and the bubble generation chamber 304 illustrated in FIG. 3 (details are described later with reference to FIGS. 4A to 4C and FIGS. 5A to 5C). As illustrated in FIG. 3, the liquid channel 302 of the liquid ejection unit is connected to the common liquid chamber 214 via the liquid supply port 208. The constituents such as the housing and the printing element substrate of the liquid ejection head of the present disclosure can be manufactured by a known method or a combination of known methods.

Hereinafter, (1) a comparable embodiment (the comparative example) and (2) an embodiment of the present disclosure are described regarding the liquid ejection unit of the liquid ejection head.

### (1) Comparative Example

Hereinafter, as the comparative example of the present disclosure, description is provided using the ejection port having a known shape as an example. In the comparative example, an aspect ratio of the ejection port having a known shape (the ejection port described in PTL 1) is changed to be within a width W of the bubble generation chamber 304 in the present disclosure. Using the above-described ejection port as an example, the liquid ejection unit is described with reference to FIGS. 4A to 4C.

The liquid ejection unit of the comparative example illustrated in FIGS. 4A to 4C includes the electrothermal conversion element 212, the ejection port 210 as an opening portion to eject the liquid, the liquid channel 302, and the bubble generation chamber 304. The bubble generation chamber 304 has a rectangular shape including a long side (the longitudinal direction) and a short side (the transverse direction). In the comparative example, the short side of bubble generation chamber 304 has the width W. In FIGS. 4A to 4C, the liquid ejection unit includes one liquid channel 302, which is a path to flow the liquid into the bubble generation chamber 304, on one short side. FIG. 4A is a front view of the liquid ejection unit, FIG. 4B is a cross-sectional view taken along IVb-IVb in FIG. 4A, and FIG. 4C is an enlarged view illustrating the shape of the ejection port in FIG. 4A.

In the printing element substrate of the comparative example illustrated in FIG. 4A, the ejection ports of the liquid ejection unit are arrayed in a straight line at 1200 dpi, and the width W of the short side of the bubble generation chamber 304 is 17 μm. Additionally, in the liquid ejection unit, the ejection port 210 having an opening area that allows for ejection of a liquid amount comparable to 3.5 μl is provided. The dimension of the ejection port has a relationship of M>L [that is, M/L>1.0)], which is a vertically long shape along the longitudinal direction, such that the ejection port 210 is within the width W of the short side of the bubble generation chamber 304. In this case, M that is the dimension of the ejection port is a length of the ejection port in the longitudinal direction, and L is a length of the ejection port in the transverse direction.

FIG. 4B illustrates a cross section of the liquid ejection unit (a cross section taken along IVb-IVb in FIG. 4A). As illustrated in FIG. 4B, in the comparative example, a distance from the electrothermal conversion element 212 to an ejection port surface is Dh, and a length thereof is 23 μm. Additionally, in the comparative example, a distance from a surface of the electrothermal conversion element 212 to a ceiling of the liquid channel 302 is Di, and a length thereof is 17 μm.

FIG. 4C illustrates the ejection port having the shape with an aspect ratio changed from that of the ejection port described in PTL 1 so as to be within the width W of the short side of the bubble generation chamber 304.

The ejection port 210 of the comparative example has a flat bilobate shape as illustrated in FIG. 4C. The ejection port 210 includes protrusions 402 and 402′ facing each other in the longitudinal direction of the ejection port 210 (the Y axis direction). The protrusions include leading end portions 408 and 408′. With the protrusions 402 and 402′, the ejection port 210 forms the flat bilobate shape having the longitudinal direction (the Y axis direction) and the transverse direction (the X axis direction). Additionally, the ejection port 210 of the comparative example includes opening portions 404 and 404′ in the longitudinal direction of the flat bilobate shape and an opening portion 406 of a portion bridging the two opening portions of the bilobate shape (hereinafter, also referred to as a bridging portion). In the comparative example, regions of the opening portions 404 and 404′ in the longitudinal direction are referred to as first regions, and the opening portion 406 of the bridging portion is referred to as a second region. That is, the first regions are regions excluding the protrusions of the ejection port and are regions of the opening portions that are along the longitudinal direction and partitioned by the protrusions. Additionally, the second region is a region excluding the protrusions of the above-described ejection port and is a region bridging the above-described first regions between the above-described facing protrusions (particularly, between the two facing protrusions 402 and 402′). Note that, the second region is configured to hold a liquid surface connecting to a column-shaped liquid extending to the outside of the ejection port in a case of ejecting the liquid from the ejection port. As illustrated in FIG. 4C, the second region is arranged between the leading end portions 408 and 408′ of the protrusions 402 and 402′ of the ejection port. Moreover, in the above-described first regions (the portions corresponding to the opening portions 404 and 404′ in the longitudinal direction), a portion parallel to the protrusions 402 and 402′ (a region obtained by excluding a region of a height indicated by H from a height indicated by M in the first regions in FIG. 4C) is referred to as a “protrusion-adjacent portion” or a “portion adjacent to the protrusion.” As illustrated in FIG. 4C, the ejection port 210 includes two end portions 410 and 410′ in the first regions. In the comparative example, edge portions 412 and 412′ of the ejection port 210 along the longitudinal direction illustrated in FIG. 4C are included. In the comparative example, the edge portions are referred to as an “edge portion in the longitudinal direction” or an “outer edge portion in the longitudinal direction.”

In the comparative example, as illustrated in FIG. 4C, the dimension of the flat bilobate shape in the longitudinal direction (the dimension between the two end portions 410 and 410′ of the first regions) is M, and the dimension in the transverse direction is L. Additionally, the dimension between the protrusions 402 and 402′ (the dimension of the opening portion of the bridging portion along the longitudinal direction) is H. In the present embodiment, a half width of the protrusions 402 and 402′ is “a.” In FIGS. 4A to 4C, each dimension is M=18.8 μm, L=11.8 μm, H=7.7 μm, and a=2.0 μm. In this case, the total width of the first regions 404 and 404′ is (L−a), and a width of one of the first regions is (L−a)/2. A ratio (L−a)/2L between the width (L−a)/2 of the one first region and the width L in the transverse direction is 0.415. The ejection port in FIG. 4C is the comparative example of the first embodiment of the present disclosure illustrated in FIGS. 5A to 5C described below.

### (2) Embodiment of Present Disclosure

### First Embodiment

The liquid ejection unit of the first embodiment of the present disclosure is described below.

FIGS. 5A to 5C illustrate the liquid ejection unit of the first embodiment in the present disclosure. The configuration and the dimension other than the shape of the ejection port 210 are similar to that of the ejection port described with reference to FIGS. 4A to 4C. Specifically, the liquid ejection unit of the present embodiment illustrated in FIGS. 5A to 5C includes the electrothermal conversion element 212, the ejection port 210 as the opening portion to eject the liquid, the liquid channel 302, and the bubble generation chamber 304. The bubble generation chamber 304 has the rectangular shape including the long side (the longitudinal direction) and the short side (the transverse direction). In the present embodiment, the short side of the bubble generation chamber 304 has the width W. In the present embodiment, the liquid ejection unit includes one liquid channel 302, which is a path to flow the liquid into the bubble generation chamber 304, on one short side. FIG. 5A is a front view of the liquid ejection unit, FIG. 5B is a cross-sectional view taken along Vb-Vb in FIG. 5A, and FIG. 5C is an enlarged view illustrating the shape of the ejection port in FIG. 5A.

In the printing element substrate of the present embodiment illustrated in FIG. 5A, the ejection ports of the liquid ejection unit are arrayed in a straight line at 1200 dpi, and the width W of the short side of the bubble generation chamber 304 is 17 μm. Additionally, in the liquid ejection unit, the ejection port 210 having an opening area that allows for ejection of a liquid amount comparable to 3.5 μl is provided. The dimension of the ejection port has a relationship of M>L [that is, M/L>1.0)], which is a vertically long shape along the longitudinal direction. In this case, M that is the dimension of the ejection port is the length of the ejection port in the longitudinal direction, and L is the length of the ejection port in the transverse direction.

FIG. 5B illustrates a cross section of the liquid ejection unit (a cross section taken along Vb-Vb in FIG. 5A). As illustrated in FIG. 5B, in the present embodiment, the distance from the electrothermal conversion element 212 to the ejection port surface is Dh, and the length thereof is 23 μm. Additionally, in the present embodiment, the distance from the surface of the electrothermal conversion element 212 to the ceiling of the liquid channel 302 is Di, and the length thereof is 17 μm.

Hereinafter, the shape of the ejection port 210 illustrated in FIG. 5C is described in detail.

The ejection port 210 of the present embodiment has a substantially H shape as illustrated in FIG. 5C. The ejection port 210 includes protrusions 502 and 502′ facing each other in the longitudinal direction of the ejection port 210 (the Y axis direction). The protrusions include leading end portions 508 and 508′. With the protrusions 502 and 502′, the ejection port 210 forms the substantially H shape having the longitudinal direction (the Y axis direction) and the transverse direction (the X axis direction). Additionally, the ejection port 210 of the present embodiment includes opening portions 504 and 504′ in the longitudinal direction of the substantially H shape and an opening portion 506 of a portion bridging the two opening portions (hereinafter, also referred to as a bridging portion). In the present embodiment, regions of the opening portions 504 and 504′ in the longitudinal direction are referred to as first regions, and a region of the opening portion 506 of the bridging portion is referred to as a second region. That is, the first regions are regions excluding the protrusions of the ejection port and are regions of the opening portions that are along the longitudinal direction and partitioned by the protrusions. Additionally, the second region is a region excluding the protrusions of the above-described ejection port and is a region bridging the above-described first regions between the above-described facing protrusions (particularly, between the two facing protrusions 502 and 502′). Note that, the second region is configured to hold the liquid surface connecting to the column-shaped liquid extending to the outside of the ejection port in a case of ejecting the liquid from the ejection port. As illustrated in FIG. 5C, the second region 506 is arranged between the leading end portions 508 and 508′ of the protrusions 502 and 502′ of the ejection port. Moreover, in the above-described first regions (the portions corresponding to the opening portions 504 and 504′ in the longitudinal direction), a portion parallel to the protrusions 502 and 502′ (a region obtained by excluding a region of a height indicated by H from a height indicated by M in the first region in FIG. 5C) is referred to as a “protrusion-adjacent portion” or a “portion adjacent to the protrusion.” In addition, as illustrated in FIG. 5C, the ejection port 210 includes two end portions 510 and 510′ in the first regions. In the present disclosure, edge portions 512 and 512′ of the ejection port 210 along the longitudinal direction illustrated in FIG. 5C are included. In the present embodiment, the edge portions are referred to as an “edge portion in the longitudinal direction” or an “outer edge portion in the longitudinal direction.”

In the ejection port 210 of the present disclosure, the number of the protrusions in one embodiment may be two. Additionally, in one embodiment, the ejection port 210 of the present disclosure can be symmetrical in the longitudinal direction and the transverse direction (symmetrical vertically and horizontally).

In the present embodiment, as illustrated in FIG. 5C, the dimension of the substantially H shape in the longitudinal direction (the dimension between the two end portions 510 and 510′ of the first region) is M, and the dimension in the transverse direction is L. Additionally, the dimension between the protrusions 502 and 502′ (the dimension of the opening portion of the bridging portion along the longitudinal direction) is H. In the present embodiment, a half width of the protrusions 502 and 502′ is “a.” In the present embodiment, the total width of the first regions 504 and 504′ is (L−a), and a width of one of the first regions is (L−a)/2.

As illustrated in FIG. 5C, the dimension of the ejection port 210 has a relationship of M>L [that is, M/L>1.0)], which is a vertically long shape along the longitudinal direction. As each dimension of M and L of one embodiment, M is 20.7 μm, and Lis 11.8 μm. Additionally, as the dimensions of H and a of one embodiment, His 6.8 μm, and a is 4.3 μm.

In the present embodiment, as illustrated in FIG. 5C, the width of the first region 504 or 504′ [a width of the one first region in a direction (the X axis direction) perpendicular to the longitudinal direction] can be obtained as (L−a)/2. In this case, the ratio (L−a)/2L between the width (L−a)/2 of the one first region (the opening portion 504 or 504′ in the longitudinal direction) and the width L of the ejection port in the substantially H shape in the transverse direction is 0.318. Comparing with the ejection port of the comparative example illustrated in FIGS. 4A to 4C, the ejection port of the present embodiment includes a thicker protrusion, and accordingly the region of the protrusion-adjacent portion in the first region is narrower. Therefore, in the ejection port 210 of the present disclosure, a resistance to the ejected liquid in an opening region portion (the entire first and second regions) is higher than that in the ejection port of the comparative example.

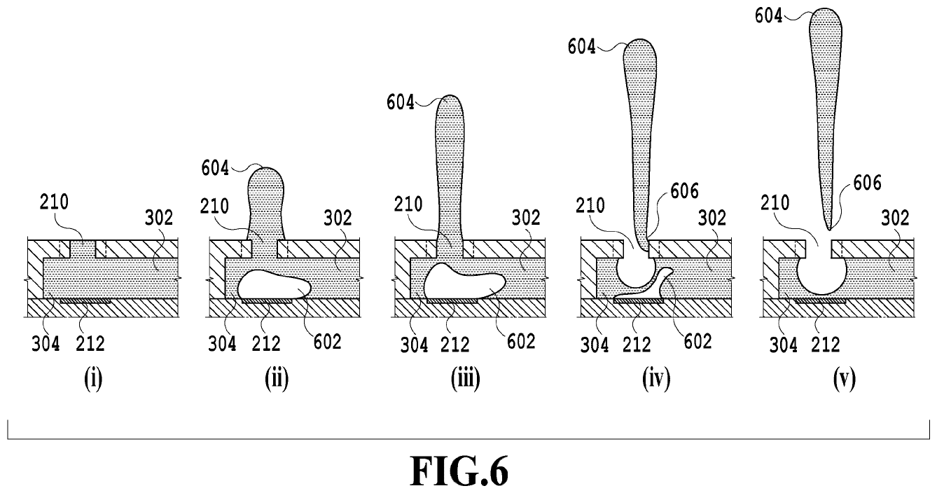

Next, an ejection process of the liquid in the ejection port provided with the protrusion is described with reference to FIGS. 6, 7 and 8, and FIGS. 9A and 9B while comparing the ejection port of the above-described first embodiment and the ejection port of the comparative example.

FIG. 6 is a diagram of an ejection step illustrating a general ejection process of the liquid in the ejection port provided with the protrusion. The dimension of the liquid ejection unit illustrated in FIG. 6 is equivalent to the dimension described in FIG. 4. FIG. 6 (i) illustrates a situation before the electrothermal conversion element 212 is driven. In this state, the liquid exists in the ejection port and is not in an ejection state. FIG. 6 (ii) illustrates a state in a case where driving of the electrothermal conversion element 212 is started. In this state, an air bubble 602 is generated in the liquid channel 302, a liquid column 604 is generated, and ejection of the liquid is started (in the present specification, the liquid to be ejected or the ejected liquid is also referred to as a liquid droplet or a liquid column). In this stage, the air bubble grows in two directions, which are an ejection port direction and a liquid channel direction. FIG. 6 (iii) illustrates a state in which the air bubble 602 and the liquid column 604 grow. As illustrated in FIG. 6 (iii), the liquid is ejected as the liquid column 604 while the size of the air bubble 602 grows to the maximum in the liquid channel. Thereafter, the air bubble 602 transitions to a vanishing process of the bubble, and the air bubble 602 contracts while drawing the liquid from an ejection port side. FIG. 6 (iv) illustrates a process in which the air bubble 602 contracts. In this process, during the process in which the air bubble 602 contracts, the liquid is ejected while a tail portion 606 of the liquid column 604 is adhered to a protrusion leading end. FIG. 6 (v) illustrates a state in which a series of the ejection operation is completed. The series of the ejection operation is completed with the tail portion 606 of the liquid column ejected in this process being separated from the protrusion.

Characteristics of the ejection port provided with the protrusion in the ejection port are between the steps of FIG. 6 (iii) and FIG. 6 (iv). That is, in these steps, there are the characteristics in the action in which a meniscus in the second region falls down in a direction toward the electrothermal conversion element 212, and the tail portion 606 of the liquid column is formed between the protrusions of the ejection port facing each other. In the liquid ejection head, it is important to suppress the satellites and the mist of the ejected liquid. In order to enhance the suppression effect as described above, it is important to allow the meniscus in the second region to fall down rapidly and make the tail portion 606 of the liquid column remaining between the facing protrusions of the ejection port narrow promptly. This makes it possible to separate the protrusions and the tail portion of the liquid column in an early timing. As a result of the above, the entire length of the liquid column is formed short, and the satellites and the mist are suppressed. On the other hand, in a case where the tail portion 606 of the liquid column remains between the protrusions of the ejection port, and the separation from the ejection portion is late, the entire length of the ejected liquid column becomes long, and the liquid splits into the main droplet and many sub droplets (the satellites or the mist) during spout, which increases the amount of the satellites and the mist.

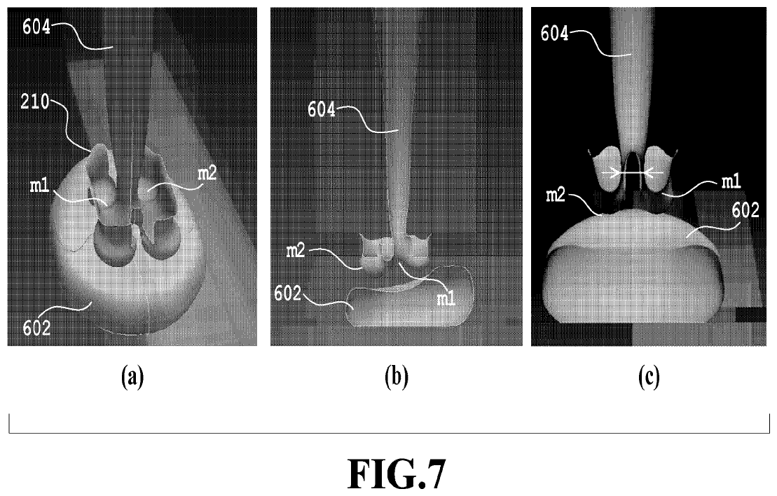

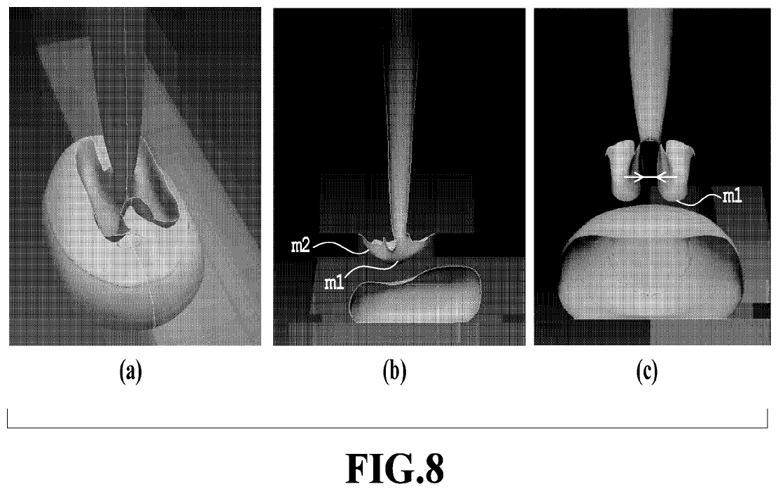

The movement of the liquid in the ejection port of the liquid ejection head of the present disclosure is further described with reference to FIGS. 7 and 8. The movement of the liquid in the ejection port was analyzed by using a fluid simulator. As the fluid simulator, Ansys® Fluent® was used. FIGS. 7 and 8 illustrate results of simulation of the movement of the liquid during the ejection operation of the liquid and each illustrate a situation of the liquid in the ejection port in the timing between the ejection steps (iii) and (iv) described with reference to FIG. 6.

FIG. 7 is a behavior of the liquid in the ejection port illustrated in FIGS. 4A to 4C (the comparative example). FIGS. 7(a), 7(b), and 7(c) each illustrate a situation of viewing a situation of the liquid inside the ejection port in the same timing from different directions. FIG. 7(a) illustrates a situation of the liquid inside the ejection port in a case where the liquid ejection unit is viewed from the ejection port side to an electrothermal conversion element side. FIG. 7(b) illustrates a cross section of the liquid ejection unit, which is the cross section taken along IVb-IVb in FIG. 4A. FIG. 7(c) is a cross section taken along VIIc-VIIc in FIG. 4A and illustrates a situation of viewing the bubble generation chamber 304 toward a liquid channel 302 side (in the −Y direction in FIGS. 4A to 4C).

As illustrated in FIG. 7(a), along with the vanishing of the air bubble 602, meniscuses m1 and m2 are drawn to the inside of the bubble generation chamber 304. In the present specification, the meniscus m1 indicates a meniscus in a central portion of the first region of the ejection port (each region of the opening portions 504 and 504′ of the ejection port along the longitudinal direction). Additionally, the meniscus m2 indicates a meniscus in a portion other than the central portion of the first region of the ejection port. Next, as illustrated in FIG. 7(a), the meniscus in the central portion of the first region indicated by the meniscus m1 remains on an ejection direction side (a +Z direction in FIGS. 4A to 4C) with respect to the meniscus m2 in the portion other than the central portion of the first region of the ejection port. In addition, it can be seen that the meniscus m2 is connected with the tail portion 606 of the ejected liquid.

As described above, in the ejection port provided with the protrusion, it is important to allow the meniscus m1 in the first regions 504 and 504′ other than the second region 506 (the region between the protrusions) to fall down to the inside of the bubble generation chamber in an early timing and to form the tail portion 606 of the ejected liquid narrow. However, in FIG. 7(a), a portion of the meniscus m1 in the first region remains on the ejection port side more than the meniscus in the other region.

The situation in FIG. 7(a) is illustrated better in the cross-sectional view in FIG. 7(b). As illustrated in FIG. 7(b), comparing the meniscus m1 and the meniscus m2, the meniscus m2 is drawn more to the inside of the bubble generation chamber. On the other hand, it can be seen that the meniscus m1 remains on the ejection port side more than the meniscus m2.

As illustrated in the cross-sectional view in FIG. 7(c), the tail portion of the ejected liquid is connected to the meniscus m1, and a portion sandwiched by arrows in FIG. 7(c) indicates the narrowest portion of the tail portion of the ejected liquid. It can be seen that the meniscus m2 is drawn deeper to the inside of the bubble generation chamber than the meniscus m1.

FIG. 8 illustrates a behavior of the liquid in the ejection port of the first embodiment illustrated in FIGS. 5A to 5C. As with FIG. 7, FIGS. 8(a), 8(b), and 8(c) each illustrate a situation of viewing a situation of the liquid inside the ejection port in the same timing from different directions. As with FIG. 7, FIG. 8(a) illustrates a situation of the liquid inside the ejection port in a case where the liquid ejection unit is viewed from the ejection port side to the electrothermal conversion element side. FIG. 8(b) illustrates a cross section of the liquid ejection unit, which is the cross section taken along Vb-Vb in FIG. 5A. FIG. 8(c) is a cross section taken along VIIIc-VIIIc in FIG. 5A and illustrates a situation of viewing the bubble generation chamber 304 toward the liquid channel 302 side (in the −Y direction in FIG. 5).

As illustrated in FIG. 8(a), the remaining meniscus m1, which is seen in FIG. 7(a), is not seen in the central portion of the first region of the ejection port. As illustrated in FIG. 8(b), comparing the meniscus m1 and the meniscus m2, the meniscus m1 is drawn into the bubble generation chamber more than the meniscus m2. Thus, in the present embodiment, the relationship between the meniscus m1 and the meniscus m2 illustrated in FIG. 7(b) is inverted. As illustrated in FIG. 5C, this is the action obtained by making the half width a of the protrusion of the ejection port thick to reduce the area of the region of the portion adjacent to the protrusion in the first regions 504 and 504′, and increasing the resistance while the ejected liquid passes through the ejection port. With the resistance in the region of the portion adjacent to the protrusion being increased, the resistance while the liquid passes through the ejection port is reduced in the central portion of the first region, and thus the relationship between the meniscus m1 and the meniscus m2 is inverted.

With reference to FIG. 8(c), it can be seen that the meniscus m1 is drawn deeper to the inside of the bubble generation chamber 304 than the meniscus m1 in FIG. 7(c). A portion sandwiched by arrows in FIG. 8(c) is the narrowest portion of the tail portion of the ejected liquid droplet. The narrowest portion is narrower than that in FIG. 7(c). In a case where the tail portion of the ejected liquid droplet is made narrow in an early timing from the start of the liquid ejection, the timing of the separation of the tail portion of the ejected liquid droplet from the protrusion portion of the ejection port also becomes earlier, accordingly. In a case where the timing of the separation is early, it is possible to shorten the entire length of the ejected liquid droplet and to suppress the generation of the satellites and the mist in a case where the liquid droplet spouts.

Thus, in the ejection port provided with the protrusion of the present disclosure, it is possible to obtain a desired behavior of the meniscus by controlling a resistance distribution to the ejected liquid in the region in the ejection port. As a result of the study about the ejection port for the present disclosure, it is found out that it is desirable to satisfy the following conditions in order to obtain the behavior of the meniscus as illustrated in FIG. 8. That is, in one embodiment in the ejection port of the present disclosure, the ratio [(L−a)/2L] between the width (L−a)/2 of the one first region and the width L of the ejection port in the substantially H shape in the transverse direction can be smaller than 0.4 [(L−a)/2L<0.4]. Additionally, in one embodiment, the ratio [(L−a)/2L] between the width (L−a)/2 of the one first region and the width L of the ejection port in the substantially H shape in the transverse direction may be 2/L or greater and smaller than 0.4. In other words, in a case of arranging the ejection ports at high density, it is required to make the length of L short, and accordingly, the outer edge portion in the longitudinal direction of the ejection port in the substantially H shape becomes close to the center of the ejection port (the width L of the ejection port in the transverse direction becomes short). In a case where the width of the ejection port in the transverse direction becomes short, and the outer edge portion in the longitudinal direction becomes close to the center of the ejection port, the resistance in the center portion of the first region is accordingly increased. Thus, the behavior of the meniscus m1 is inhibited as illustrated in FIG. 7 in some cases. Therefore, in a case where the width L of the ejection port in the transverse direction is made small because of the necessity of arranging the ejection ports at high density, it is required to reduce also the width (L−a)/2 of the first region simultaneously and to control the balance of the resistance in the ejection port. The balance is indicated by the relationship (L−a)/2L<0.4. As described above, as for the ejection port of the comparative example illustrated in FIGS. 4A to 4C, (L−a)/2L is 0.415, which does not satisfy the conditions. As for the ejection port of the embodiment of the present disclosure illustrated in FIGS. 5A to 5C, (L−a)/2L is 0.318, which satisfies the above-described conditions.

Additionally, in the ejection port 210 of the present disclosure, in a case where the distance between the leading ends of the protrusions of the ejection port is H, desirably, a relationship (L−a)/2<H is satisfied. With the above-described relationship being satisfied, the balance between the first regions and the second region in the ejection port becomes suitable to execute the ejection method of the present disclosure.

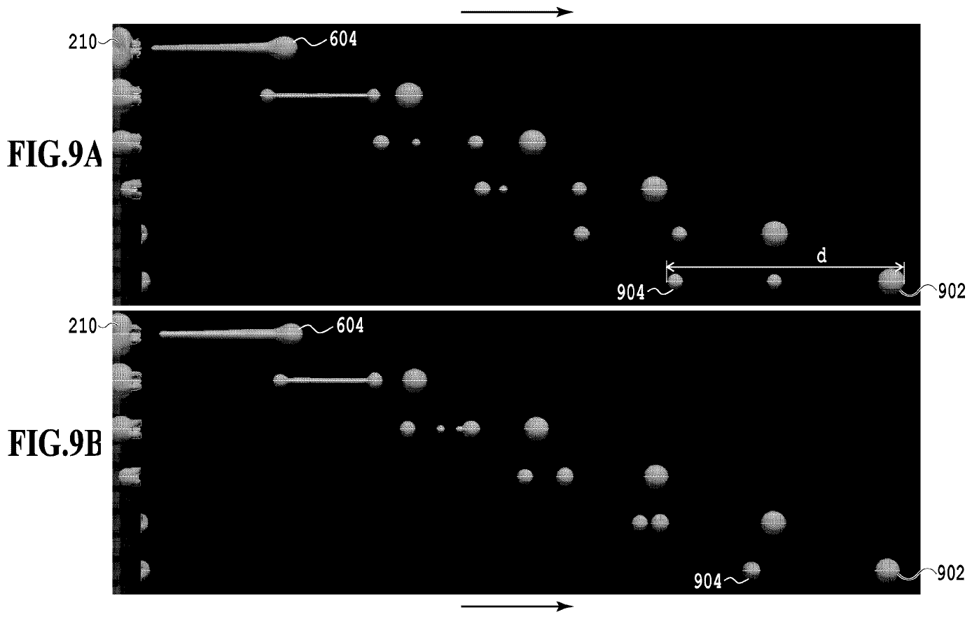

Next, a flying state of the ejected liquid (the liquid droplet) 604 is described with reference to FIGS. 9A and 9B. FIG. 9A illustrates a result of simulating the flying state in the shape of the ejection port of the comparative example illustrated in FIGS. 4A to 4C. FIG. 9B illustrates a result of simulating the flying state in the shape of the ejection port of the first embodiment of the present disclosure in FIGS. 5A to 5C. FIGS. 9A and 9B illustrate that time elapses from the top layer, at which the bubble generation starts, to the bottom layer and illustrate how the main droplet and the satellites fly over time. In each of FIGS. 9A and 9B, the liquid droplet 604 flies in a direction indicated by an arrow in FIG. 9A or 9B [a direction from the left side of the paper surface of FIG. 9A or 9B to the right side of the paper surface on the opposite side].

The liquid droplet 604 illustrated in FIG. 9A was simulated to have an ejection speed of 9.9 m/s and an ejection amount of 3.8 ng. Additionally, in a case of performing measurement based on the bubble generation start time of 0 μs, the time taken for the ejection port 210 and the liquid droplet 604 to separate from each other was 7.7 μs. Moreover, a distance d between a front end of a main droplet 902 after 48 μs and a rear end of the last one of satellites 904 was 149.5 μm, and the number of the satellites was two (see the illustration of the flying at the bottom layer in FIG. 9A). In contrast, FIG. 9B illustrates the ejection state of the ejection port in the first embodiment of the present disclosure, in which the ejection speed was 9.6 m/s, the ejection amount was 3.5 ng, and the time taken for the liquid droplet to be separated was 7.1 μs. The distance d between the main droplet and the satellites was 98.2 μm (see the illustration of the flying at the bottom layer in FIG. 9B). Each result is summarized in Table 1.

TABLE 1

| | | | | distance |
|---|---|---|---|---|
| | | | | between main |
| ejection | ejection | ejection | separation | droplet − |
| port | speed | amount | time | satellites |
| shape | (m/s) | (ng) | (μs) | (μm) |
| comparative | 9.9 | 3.8 | 7.7 | 149.5 |
| example | | | | |
| first | 9.6 | 3.5 | 7.1 | 98.2 |
| embodiment | | | | |

Thus, with the shape of the ejection port of the first embodiment of the present disclosure, it is possible to control the behavior of the meniscus and hasten the timing of the separation between the tail portion 606 of the ejected liquid droplet and the ejection port. As a result, it is possible to shorten the entire length of the liquid droplet 604 in a case where the liquid droplet 604 is separated from the ejection port. Thus, it is possible to reduce the number of the satellites and to shorten the distance between the main droplet and the satellites for the subsequent flying state of the main droplet and the satellites. As a result, in a case where the ejected liquid lands on the printing medium, the misalignment of the landing position between the main droplet and the satellites is reduced, and it is possible to obtain a good print result. In contrast to the shape of the ejection port of the present disclosure, under the conditions of the simulation in this embodiment, the number of the satellites was one. However, with the shape of the ejection port of the present disclosure, it is also possible to make the number of the satellites zero by adjusting the ejection speed, a physical property value of the liquid (for example, the ink), the shape or the dimension of the ejection port, and the like. In order to make the number of the satellites zero, in one embodiment, the ejection speed of the liquid can be set to 12 m/s or smaller, and a dynamic surface tension (Y) of the physical property value of the liquid (for example, the ink) can be set to 40 mM/m or greater.

In addition, although the ejection state of the liquid droplet regarding the shape of the ejection port illustrated in FIGS. 5A to 5C is described that the ejection amount is 3.5 μl in the first embodiment, the above-described result is independent of the ejection amount. For example, in a case where each parameter of the shape of the ejection port is M=26.8, L=14.5, a=7.4, and H=10.3, an opening area that 5.7 μl of the liquid droplet can be ejected is obtained, and the condition (L−a)/2L<0.4 is also satisfied.

With the ejection of the liquid (for example, the ink) being simulated by using the shape of the ejection port based on the above-described modification, it was confirmed that the same effect as the effect of the present disclosure is obtained. Thus, although the optimum relationship of M/L/a/H may be changed depending on the ejection amount, the effect of the present disclosure is obtained as long as the parameters satisfy (L−a)/2L<0.4 as a whole. As each numerical range of M/L/a/H in a case of the ejection amount comparable to 3.5 μl, M can be 18 μm or greater and 23 μm or smaller, L can be 10 μm or greater and 17 μm or smaller, a can be 3 μm or greater and 7 μm or smaller, and H can be 4 μm or greater and 11 μm or smaller, respectively. In a case of the ejection amount comparable to 5.7 μl, M can be 24 μm or greater and 29 μm or smaller, L can be 12 μm or greater and 17 μm or smaller, a can be 5 μm or greater and 10 μm or smaller, and H can be 5 μm or greater and 13 μm or smaller, respectively.

The results of the simulation with reference to FIGS. 7 and 8 were calculated with a viscosity of the liquid (for example, the ink) of 1.8 mPa·s. Even in a case where the calculation is performed with the viscosity of 4.0 mPa's, for example, the behavior of the liquid similar to that described with reference to FIG. 7 in a case of the comparative example and that described with reference to FIG. 8 in a case of the ejection port of the present disclosure is obtained. Accordingly, it can be seen that the difference between the comparative example and the first embodiment occurs similarly even in a case where the viscosity of the liquid droplet (for example, the ink) is changed. It is possible to consider that, since the difference in the behavior of the liquid is caused by a resistance difference between predetermined regions in the ejection port while the liquid passes through the ejection port, even in a case where the physical property of the liquid is changed, the relationship of the behavior of the meniscus of the liquid inside the ejection port is not changed as long as the relationship of the resistance difference is not changed. The desirable viscosity of the liquid (for example, the ink) in the present disclosure is 1.0 mPa's or greater and 15.0 mPa·s or smaller.

### Second Embodiment

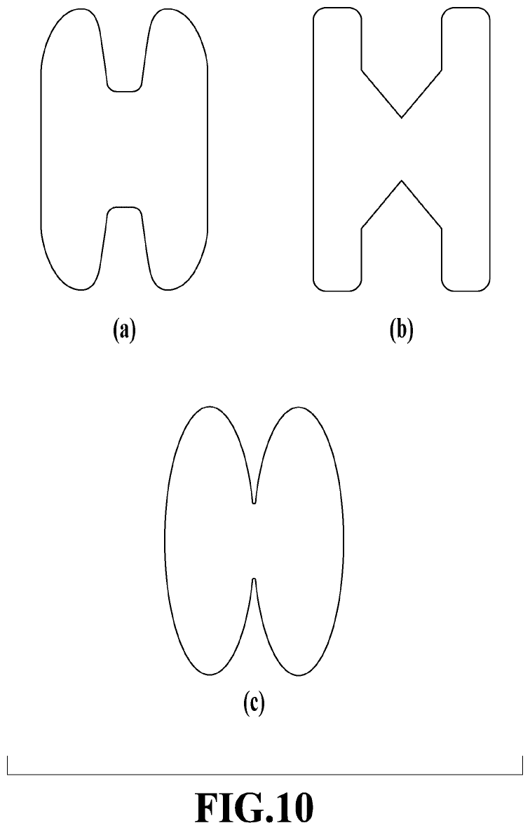

The present embodiment is described with reference to FIG. 10. FIG. 10 illustrates a shape applicable as the ejection port of the present disclosure. As described in the first embodiment, in order to control the behavior of the meniscus, it is favorable to design the dimension of the ejection port to be (L−a)/2L<0.4 taking into consideration the balance of the resistances between the predetermined regions in the ejection port. FIG. 10 (a), FIG. (b), and FIG. 10 (c) all satisfy the conditions.

FIG. 10 (a) is the ejection port having a shape in which the protrusion is thicker than that of the shape of the ejection port of the comparative example described in FIGS. 4A to 4C. With the ejection port having the above-described shape, the resistance in the protrusion-adjacent portion to the ejected liquid is increased. Additionally, the ejection port of the present disclosure may have a shape in which the leading end of the protrusion is made narrow, and a wall of a side surface (the first region side) of the protrusion is partially bent as illustrated in FIG. 10 (b). Comparing with the ejection port of the first embodiment, FIG. 10 (b) is different in that it is not a shape in which the wall of the side surface (the first region side) of the protrusion is smoothly connected. FIG. 10 (c) is the ejection port having a shape in which ellipses are combined with each other as the opening portion of the ejection port. A curved protrusion is formed at a portion at which the ellipses are joined. As illustrated in FIG. 10 (c), the ejection port of this example can have a shape in which the long axis directions of the ellipses are adjacent in parallel to be joined.

Other shapes and the conditions such as the dimension of the ejection port of the present embodiment are as described in the first embodiment.

### Third Embodiment

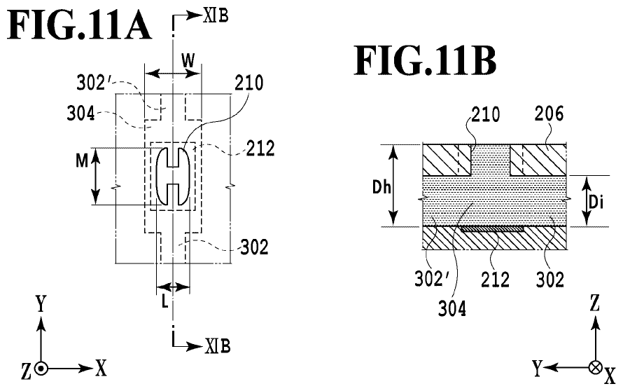

The present embodiment is described with reference to FIGS. 11A and 11B. In the above-described first and second embodiments, descriptions are provided assuming a configuration in which the liquid channel 302 is connected to one side of the bubble generation chamber 304. In addition to the configuration, the ejection port of the liquid ejection head of the present disclosure is also applicable to a configuration in which the liquid channels 302 (a first liquid channel and a second liquid channel) are facing each other and connected to two sides of the bubble generation chamber 304 as illustrated in FIGS. 11A and 11B.

Other shapes and the conditions such as the dimension of the ejection port of the present embodiment are as described in the first embodiment.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to provide a liquid ejection head that can effectively suppress satellites and mist even in a case where an arrangement space of an ejection port is small.

This application claims the benefit of Japanese Patent Application No. 2025-006113, filed Jan. 16, 2025, which is hereby incorporated by reference herein in its entirety.

What is claimed is:

1. A liquid ejection head configured to eject a liquid from an ejection port by applying energy to the liquid from an energy generation element, wherein
the ejection port includes an opening portion having a longitudinal direction and a transverse direction,
the opening portion includes a protrusion, first regions, and a second region,
the protrusion is arranged in each of facing positions of the ejection port in the longitudinal direction,
the first regions are regions excluding the protrusions of the ejection port and are regions of the opening portion that are along the longitudinal direction and partitioned by the protrusions,
the second region is a region excluding the protrusions of the ejection port and is a region of the opening portion that bridges the first regions between the facing protrusions, and
the following formulae (A) and (B) are satisfied:
$$M / L > 1. ; \qquad ( A )$$
$$( L - a ) / 2 L < 0.4 , \qquad ( B )$$
where
the maximum length in the longitudinal direction is M, the maximum length in the transverse direction is L, and a half width of the protrusion is a.

2. The liquid ejection head according to claim 1, wherein
in the ejection port, the facing protrusions are two protrusions, and the ejection port has a symmetrical shape.

3. The liquid ejection head according to claim 1, wherein
the following formula (C) is satisfied:
$$( L - a ) / 2 < H , \qquad ( C )$$
where
a distance between the protrusions of the ejection port is H.

4. The liquid ejection head according to claim 1, wherein
the opening portion has a substantially H shape or a shape in which ellipses are adjacent to each other and joined.

5. The liquid ejection head according to claim 1, wherein
the liquid ejection head includes a liquid ejection unit,
the liquid ejection unit includes a bubble generation chamber, and
the bubble generation chamber includes a first liquid channel and a second liquid channel positioned on the opposite side of the first liquid channel.
